(19) United States
(12) Patent Application Publication
(10) Pub. No.: US 2015/0158267 A1
(43) Pub. Date: Jun. 11, 2015

(54) TWO-LAYER COMPOSITE HEAT SHIELD FOR UNDERBODY OF A VEHICLE

(71) Applicant: Carcoustics TechConsult GmbH, Leverkusen (DE)

(72) Inventors: Graydon Stuckey, Fenton, MI (US); Tarah A. Hebner, Howell, MI (US); Tyler Prossen, Perry, MI (US); Tony Rasegan, Webberville, MI (US); Gerald Fitzgerald, Clinton Township, MI (US); Rainer Knapp, Oxford, MI (US)

(73) Assignee: Carcoustics TechConsult GmbH, Leverkusen (DE)

(21) Appl. No.: 14/097,714

(22) Filed: Dec. 5, 2013

(51) Int. Cl. B32B 3/30; B32B 38/00; B32B 15/14; B32B 3/26

(52) U.S. Cl. CPC B32B 3/30; B32B 3/266; B32B 38/0012; B32B 15/14

(57) ABSTRACT

Embodiments of heat shields are provided, as well as methods for producing the heat shields. One two-layer heat shield described herein includes a first layer of aluminum having opposite first and second surfaces and a second layer of a synthetic fiber material fixedly attached to the second surface of the first layer. A pattern is formed in the second layer that has a higher compression and a smaller thickness than other locations of the second layer, the pattern providing structural support for the first layer.

### FIELD OF THE DISCLOSURE

The present disclosure relates generally to heat shields, and more particularly, heat shields suitable for the underbody of a vehicle.

### BACKGROUND

Heat shields are utilized in a variety of applications on vehicles to prevent or reduce the transfer of heat to or from certain areas. It is typical for modern engines to have high working temperatures to promote fuel efficiency and power output. While thermodynamically more efficient, higher temperatures pose several problems in the design of motor vehicles and engine exhaust systems. It is common for heat shields to be interposed between passenger compartments and exhaust systems of a motor vehicle to reduce heat transfer from high temperature engine and exhaust components.

### BRIEF SUMMARY

The composite heat shields described herein can serve several important functions in certain locations on motor vehicles, including the reduction of heat transfer from certain heat sources to nearby areas of the vehicle. Additionally, such shields can reduce sound transmission to areas of the vehicle, reducing engine and exhaust noise in passenger compartments of motor vehicles. Furthermore, the heat shields can help protect motor vehicles by protecting certain vehicle components from impacts from road debris, as well as protection from weather elements.

One embodiment of a heat shield describes a two-layer heat shield including a first layer made from aluminum having opposing first and second surfaces and a second layer of a synthetic fiber material fixedly attached to the second surface of the first layer. A pattern is formed in a surface of the second layer opposite from the first layer, the pattern having a higher compression and a smaller thickness than remaining portions of the second layer. The pattern also provides structural support to the first layer.

A method of manufacturing a heat shield in accordance with the present disclosure is also described herein. According to one method, a heat shield is manufactured by fixedly attaching a first layer of aluminum to a second layer of a synthetic fiber material to form a two-layered structure and then forming the two-layer structure into a desired shape with a pattern formed in a surface of the second layer opposite from the first layer. The pattern has a higher compression and a smaller thickness than other locations of the second layer and provides structural support to the first layer.

Variations in these and other aspects of the disclosure will be described in additional detail hereafter.

### BRIEF DESCRIPTION OF THE DRAWINGS

The description herein makes reference to the accompanying drawings wherein like reference numerals refer to like parts throughout the several views, and wherein:

FIG. 1 is an isometric view of a composite heat shield with compressed features within an outer layer;

FIG. 2A is a sectional view of the heat shield of FIG. 1 as seen from substantially the line 2A-2A;

FIG. 2B is a sectional view of the heat shield of FIG. 1 as seen from substantially the line 2B-2B;

FIG. 2C is a sectional view of the heat shield of FIG. 1 as seen from substantially the line 2C-2C;

FIG. 3 is a flowchart diagram of a method of manufacturing a composite heat shield according to one implementation of the teachings herein.

### DETAILED DESCRIPTION

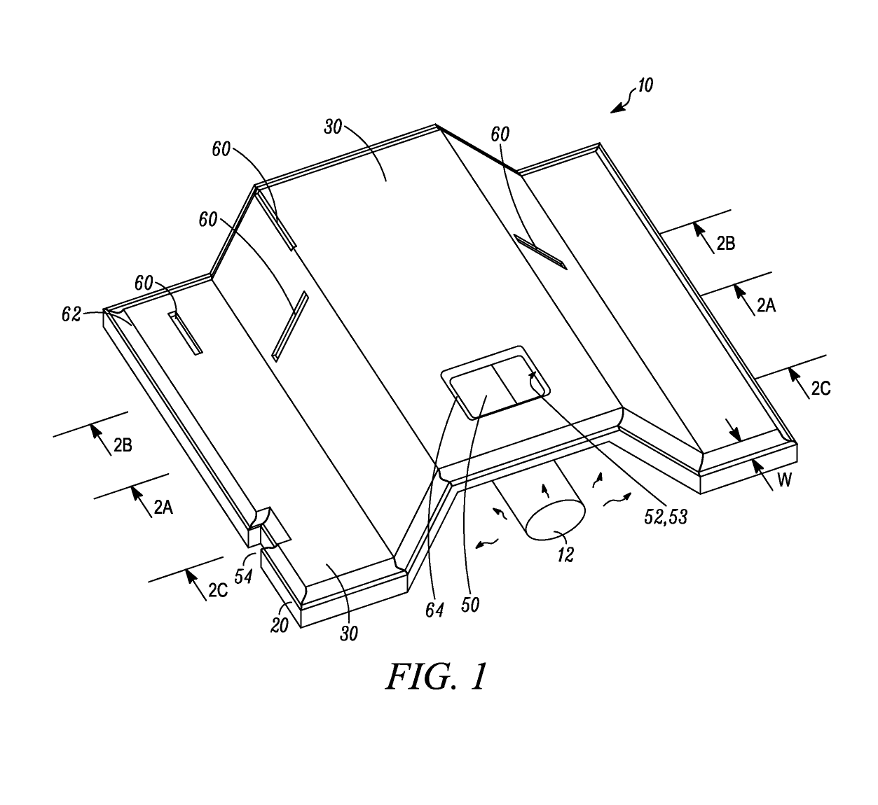

Referring first to FIG. 1, heat shield 10 is a composite heat shield including a first layer 20 and a second layer 30. Heat source 12 is shown, and can represent a variety of engine or exhaust components on a motor vehicle. It is further contemplated that heat source 12 can include any other source of high temperature where it is desired to reduce heat transfer to nearby areas opposite heat shield 10. Because first layer 20 is closest to the position of heat source 12, it is also referred to herein as inner layer 20. Conversely, second layer 30 is also referred to herein as outer layer 30 due to its further distance from heat source.

Heat shield 10 is shown having five substantially planar segments that create a concave portion around heat source 12. In further examples, heat shield 10 may be shaped with three segments, either three planar segments or a half-cylindrical segment between two planar segments. Another option is a rounded, or half-cylindrical, segment without any planar segments but possibly including mounting flanges. It is contemplated that heat shield 10 can be produced in a variety of shapes and sizes depending on several factors, such as the location or area on the vehicle and the nature of heat source 12, so these are merely examples of the possible shapes of heat shield 10. Heat shield 10 is lightweight, low cost and durable enough to withstand a variety of forces, impacts and vibrations as described in more detail herein.

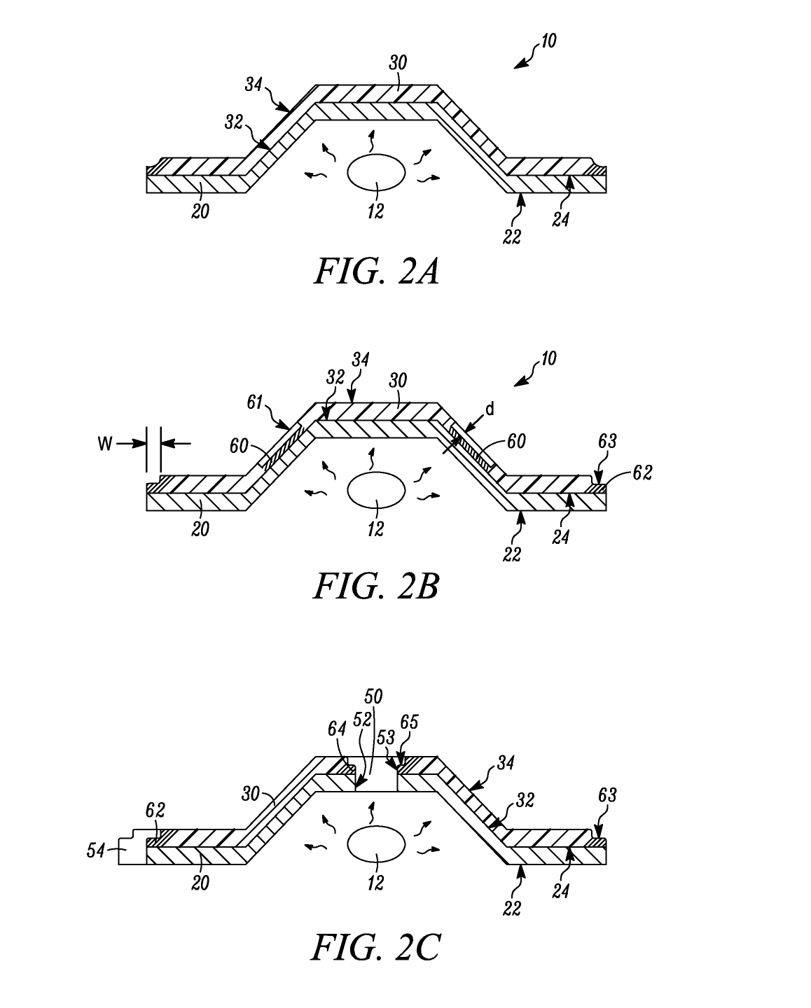

Referring now to FIG. 2A, inner layer 20 has a first inner surface 22 on the side facing heat source 12, and a second inner surface 24 opposing first inner surface 22. Outer layer 30 has a first outer surface 32 that faces inner layer 20 and a second outer surface 34 on the opposing side from first outer surface 32. Inner layer 20 and outer layer 30 are sealed together by an adhesive layer as described in further detail below.

Inner layer 20 is formed of aluminum (e.g., an aluminum foil) to provide both heat resistance and to provide a lightweight base material. It is contemplated that the thickness of inner layer 20 can vary depending on the particular application of heat shield 10. As a non-limiting example, inner layer 20 can be formed of aluminum with a thickness of approximately 0.002-0.010 inches. In addition, inner layer 20 can comprise perforated aluminum. Inner layer 20 can be perforated either with or without embossing to provide a different response to vibrations in particular applications, thus improving noise, vibration and harshness (NVH) of heat shield 10. The utilization of smaller thicknesses can minimize both the weight and cost of heat shield 10 at the same time as improving NVH. However, these efforts to minimize the weight and cost of inner layer 20 can result in a decrease in the strength needed to maintain the overall finished shape of heat shield 10.

Further strength and additional protective features are provided to heat shield 10 by outer layer 30. Outer layer 30 is produced out of material that reduces thermal and sound transmissions, and creates a durable heat shield that can withstand vibration and impacts from debris and weather when combined with inner layer 20. In the embodiments described herein, the material of outer layer 30 is a synthetic fiber material, and in particular a polyethylene terephthalate (PET) fiber. Other polymer and/or natural fibers can be used, such as polyethylene (PE), polypropylene (PP), polyamide, etc., with a goal of providing a completely recyclable finished product and improving NVH and physical properties. A fibrous outer layer 30 provides a relatively poor path for heat conduction, resulting in a lower thermal conductivity than inner layer 20. Similarly, the fibers produce a relatively poor path for vibrations and sound waves to travel from inner layer 20 through outer layer 30.

The thickness of outer layer 30 can vary depend on the application, but it is contemplated that an uncompressed thickness of a PET fiber outer layer 30 may be 2-20 mm thick. As described below, the thickness may vary at different locations of outer layer 30 due to compression. Similarly, the density of outer layer 30 can vary based upon application. In certain embodiments, a PET fiber with an area or paper density of 600-1600 grams per square meter (gsm) can be used. One implementation includes a PET fiber with a density of 1200 gsm. PET fiber can vary in denier (a unit of linear mass density of the fibers), melt point and other characteristics. Desirably, the PET fiber of outer layer 30 is itself formed of PET fibers having such different characteristics. For example, outer layer 30 may be a homogeneous composite PET material formed of four or five fibers of different deniers (such as a low melt fiber, a fine fiber, a standard fiber, a coarse fiber and optionally a high melt fiber). These relative terms are defined with respect to each other. In one non-limiting example, the composite PET fiber material of outer layer 30 can comprise 20% coarse fiber, 20% standard fiber, 20% fine fiber, 30% low melt fiber, and 10% high melt fiber. Furthermore, the example above can instead include 40% low melt fiber, without any high melt fiber in the PET fiber composite.

The PET fiber can have hydrophobic characteristics, wherein outer layer 30 is water repellant and fluid resistant. This reduces or eliminates any weight increase due to water absorption and reduces drying time of heat shield 10. Additionally, the PET fiber of outer layer 30 adds protection against impact from debris, even if inner layer 20 is damaged such that debris is able to contact outer layer 30.

Certain portions of outer layer 30 have increased compression compared to surrounding areas of outer layer 30 and are referred to as compressed features 60 herein. At least one compressed feature 60 can be formed in outer layer 30 where the material of outer layer 30 is compressed to a thickness less than surrounding material of outer layer 30. FIG. 2B shows a sectional view of heat shield 10, as viewed from line 2B-2B. As shown, compressed feature 60 has a thickness measured from the first outer surface 32 to feature surface 61 that is less than the thickness of surrounding uncompressed areas of outer layer 30 by a distance d. While compressed features are shown to be similar thicknesses, it is contemplated that outer layer 30 can be compressed in different areas at different depths.

By the inclusion of compressed features 60 on certain locations of outer layer 30, structural reinforcement for inner layer 20, and hence heat shield 10 generally, can be provided by outer layer 30. The material of outer layer 30 that is compressed to form compressed features 60 resists deformation more than uncompressed areas of outer layer 30. Thus, outer layer 30 can be designed to have stiffer sections incorporated into its structure by including compressed features 60. By this compression, the stiffness and durability of heat shield 10 can be increased over what would be available without such features, allowing for thinner layers to be utilized without additional layers or materials for structural support, reducing both cost and weight.

Each compressed feature 60 may be in the form of a “rib”—that is, a roughly linear portion in outer layer 30. Linear portions, or line segments, are desirable for both modeling and manufacturing ease and because they minimize the amount of compressed material of outer layer 30 over other shapes, such as round areas of compression. Compressed features 60 may comprise line segments formed into x-shapes or open squares, trapezoids, rectangles, etc. Compressed features 60 may also be formed of open circles or ovals, or other shapes as desired.

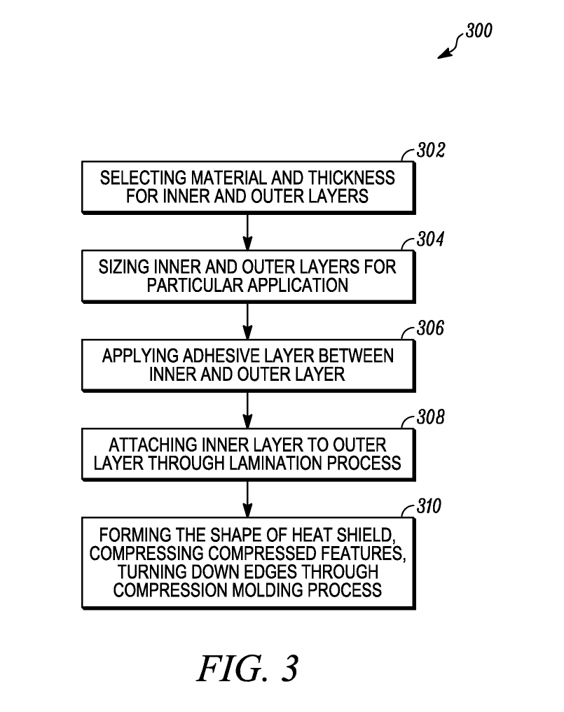

When considering the optimal configuration and locations for compressed features 60, the existence of compressed edges 62 located about the perimeter of outer layer 30 may be considered as these features also provide structural support for inner layer 20. Compressed edges 62 can be of similar thickness as compressed feature 60 as shown in FIGS. 3B and 3C. By including compressed edges 62, the heat shield 10 has a smaller overall thickness around the perimeter of heat shield 10. Compressed edges 62 may be formed during manufacture of heat shield 10 to more securely seal inner layer 20 with outer layer 30 at the outer edges of heat shield 10 and to allow for easier installation by the edges. Edge surface 63 is defined as the portion of second outer surface 34 that is compressed in a direction towards first outer surface 32 proximal the perimeter of outer layer 30.

Other compressed areas may be formed in outer layer 30 of heat shield 10 so as to provide clearance for existing components at a particular mounting location. Compressed areas may also be formed at folds/bends of the heat shield to support such as shown by example in FIG. 1. Further, open areas pierced through heat shield 10, such the areas around mounting holes for bolts or other fasteners to secure heat shield 10 in a mounted position, may also be compressed so that, like compressed edges 62, a secure seal between inner layer 20 and outer layer 30 results. Referring to FIG. 1, for example, heat shield 10 can include at least one aperture 50 and one slot 54. Each of aperture 50 and slot 54 can aid in the attachment of the heat shield to a vehicle, provide or direct airflow proximate to heat shield 10 and/or provide assistance for carrying, shipping or installing heat shield 10. As shown in FIG. 2C, which is a sectional view of heat shield 10 as viewed from line 2C-2C of FIG. 1, an aperture edge 64 is located around the perimeter of aperture 50 in outer layer 30. Aperture 50 is defined by inner surface aperture perimeter 52 and outer surface aperture perimeter 53. Aperture edge surface 65 is defined as the portion of second outer surface 34 that is compressed towards outer surface 32 near aperture 50. Like compressed edges 62, compressed aperture edge 64 may be formed to securely seal inner layer 20 with outer layer 30 about aperture 50. Slot 54, being located in the outer periphery of heat shield 10, is bordered by compressed edges 62 where outer layer 30 is compressed into contact with inner layer 20.

The compressed areas of outer layer 30, including for example, compressed features 60, compressed edges 62 and compressed aperture edge 64, together form a pattern in outer layer 30 that structurally supports the shape formed by inner layer 20. It is desirable that the amount of compressed material of outer layer 30 is minimized so as to maximize the noise suppression and thermal insulation provided by the uncompressed fibrous material of outer layer 30.

Computer aided modeling, such as finite element analysis (FEA), or prototype testing can be used to determine the optimal configuration and locations of compressed features 60 in outer layer 30 given the compressed edges 62, 64 that will result from the shape and piercings of the finished heat shield 10. For example, the two-layer heat shield structure may be formed or computer modeled with a partial pattern, such as a pre-defined width w (see FIGS. 1 and 2B) for compressed edges around internal perimeters such as around mounting holes, openings, etc., and the external perimeter of heat shield 10. Then, the analysis or testing can identify areas of heat shield 10 that require more reinforcement to meet durability or vibrational targets. Then, compressed features 60 of various shapes may be analyzed to determine the minimum pattern that will result in heat shield 10 meeting its requirements.

All edges of inner layer 20 of completed heat shield 10, including interior edges such as that formed by aperture 50, are folded down toward outer layer 30 so as to form a relatively smooth edge for transportation and handling of heat shield 10.

A method for manufacturing heat shield 10 can be described as follows, and for simplicity of explanation, illustrated in flow diagram FIG. 3 as process 300. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

As shown in step 302, material and thickness selections can be made based upon computer aided modeling (FEA) or prototype testing for the particular application of heat shield 10, with some examples discussed previously. Turning to step 304, material of inner layer 20 and outer layer 30 are sized according to the application and requirements determined above, each desirably of one piece.

In step 306, adhesive is positioned between second inner surface 24 and first outer surface 32. The adhesive may be in the form of an adhesive web, and can be a thermoset or thermoplastic adhesive that reacts to the addition of heat. Outer layer 30 is attached to inner layer 20 with adhesive through a lamination process, step 308, wherein the PET fiber of outer layer 30 is heated to react with the adhesive. As a non-limiting example, the layers can be heated using a hot press at approximately 160-180 degrees Centigrade. Upon heating, first outer surface 32 bonds with the adhesive and attaches to second inner surface 24 of inner layer 20. The heating of the outer layer 30 can partially melt material proximate to first outer surface 32 to aid the attachment of outer layer 30 to the adhesive and inner layer 20.

Once inner layer 20 and outer layer 30 are fixedly attached to each other, the assembly can be formed to a desired size and shape in step 310. The attached layers can be placed in a mold, and then through a compression molding process heat shield 10 is formed to the desired state. The compression molding can include the addition of heat to the molding process. It is also contemplated that heat shield 10 can be formed through a die stamping process using a single die assembly or a series of progressive dies.

Compressed features 60 can be accomplished by including specific structure on a mold used in the compression molding process of step 310. The specific structure can contact compressed feature 60 and apply more pressure to compressed feature 60 than surrounding areas of second outer surface 34 during the molding. This in turn causes compressed feature 60 to be compressed farther in a direction toward first outer surface 32. Similarly, if stamping heat shield 10, a male die portion can include such structure. Thus, mold or die patterns can be designed to produce specifically sized and located compressed features 60. The result is a compressed pattern in outer layer 30 that provides structural support to the inner layer 20 so as to keep the shape of heat shield 20. The molding process can also turn-down the edges of inner layer 20 such that a subsequent trimming or hemming process is not required.

It is to be noted that heat shield 10 can be attached to a variety of structures located on a motor vehicle depending on the particular application of heat shield 10. As non-limiting examples, attachment means can include threaded fasteners with or without washers, push-pins with or without washers, or integral tabs and flanges that are designed to attach to structure located on the vehicle. Heat shield 10 can include holes, flanges, and slots to accommodate such attachment means.

Heat shield 10 can provide thermal protection from heat source 12 by reflecting thermal radiation energy in a direction away from an area of the vehicle. Additionally, heat shield 10 can reduce thermal conduction by utilizing materials that have low thermal conductance. Further yet, heat shield 10 can provide protection from thermal convection, by shielding areas from fluid and air in contact with heat source 12. In a similar fashion, heat shield 10 can provide sound protection from engine noise and/or road noise by reflecting sound waves and resisting sound travel vibration through the materials of heat shield 10.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A heat shield, comprising:
a two-layer structure formed of a first layer of aluminum having opposing first and second surfaces and a second layer of a synthetic fiber material fixedly attached to the second surface of the first layer, wherein a pattern is formed in a surface of the second layer opposite from the first layer, the pattern having a higher compression and a smaller thickness than other locations of the second layer and the pattern providing structural support to the first layer.

2. The heat shield of claim 1 wherein the synthetic fiber material is polyethylene terephthalate.

3. The heat shield of claim 2 wherein a fiber area density of the second layer is between approximately 600 gsm and 1600 gsm.

4. The heat shield of claim 2 wherein the polyethylene terephthalate is a homogenous mixture comprising a plurality of fibers having different deniers.

5. The heat shield of claim 1 wherein the first layer has a thickness between 0.005 inches and 0.010 inches.

6. The heat shield of claim 1 wherein the first layer is perforated.

7. The heat shield of claim 6 wherein the first surface of the first layer is embossed.

8. The heat shield of claim 1 wherein the pattern includes an edge portion of the second layer proximate the perimeter of the first layer.

9. The heat shield of claim 1 wherein the pattern includes a plurality of line segments.

10. A method for producing a heat shield, the method comprising:
fixedly attaching a first layer of aluminum to a second layer of synthetic fiber material to form a two-layer structure, the first layer having opposing first and second surfaces and the second layer fixedly attached to the second surface of the first layer; and
forming the two-layer structure into a desired shape with a pattern formed in a surface of the second layer opposite from the first layer, the pattern having a higher compression and a smaller thickness than other locations of the second layer and the pattern providing structural support to the first layer.

11. The method of claim 10 wherein the forming comprises a compression molding process.

12. The method of claim 10 wherein fixedly attaching the first layer to the second layer comprises:
layering a thermosetting or thermoplastic adhesive between the second surface of the first layer and the second layer; and
laminating the first layer with the second layer.

13. The method of claim 12 wherein the laminating includes laminating while heating the first layer and the second layer.

14. The method of claim 10 wherein the synthetic fiber material is polyethylene terephthalate.

15. The method of claim 13 wherein the fiber area density of the second layer is between approximately 600 gsm and 1600 gsm.

16. The method of claim 10 wherein the thickness of the first layer is between 0.005 inches and 0.010 inches.

17. The method of claim 10 wherein, as a result of the forming, the pattern includes an edge portion of the second layer proximate the perimeter of the first layer.

18. The method of claim 10, further comprising:
generating the pattern for the forming.

19. The method of claim 18 wherein generating the pattern for the forming comprises:
computer modeling the heat shield in the desired shape with a partial form of the pattern; and
analyzing the heat shield with the partial form of the pattern to determine locations along the first layer requiring reinforcement.

20. The heat shield of claim 18 wherein the pattern includes a plurality of line segments.
